(19) United States
(12) Patent Application Publication
(10) Pub. No.: US 2019/0035219 A1
(43) Pub. Date: Jan. 31, 2019

(54) Information Processor, Recording Medium, and Game Controlling Method

(71) Applicant: Universal Entertainment Corporation, Tokyo (JP)

(72) Inventors: Masaki OYAMA, Tokyo (JP); Atsushi KUMITA, Tokyo (JP); Toshikazu JINNOUCHI, Tokyo (JP)

(21) Appl. No.: 16/044,130

(22) Filed: Jul. 24, 2018

(30) Foreign Application Priority Data
Jul. 28, 2017 (JP) 2017-146616

(51) Int. Cl. G07F 17/32; G07F 17/34

(52) U.S. Cl. CPC G07F 17/3267; G07F 17/3213; G07F 17/34; G07F 17/3209

(57) ABSTRACT

The frequency of repetition of a bonus game is easily adjusted. An information processor 1 executes processes of: starting a base game on a display 2; in the base game, determining a bonus trigger at a predetermined probability based on base game probability determination data; running, on the display, a bonus game based on bonus game probability determination data with which the game can be more advantageous than the base game, when the bonus trigger is determined; and executing a random determination game including random determination of whether to continue the bonus game based on random determination game probability determination data which is different from the base game probability determination data and the bonus game probability determination data, after the running of the bonus game.

### CROSS-REFERENCE TO RELATED APPLICATION

This application claims the benefit of Japanese Unexamined Patent Publication No. 2017-146616 filed Jul. 28, 2017, which application is incorporated herein by reference in its entirety.

### FIELD OF THE INVENTION

The present invention relates to an information processor, a recording medium, and a game control method.

### BACKGROUND OF THE INVENTION

Patent Literature 1 (Specification of Publication of U.S. Patent application No. 2011/0118003) recites a gaming machine which is configured to execute a normal game starting upon receiving a bet and to award a payout in accordance with a result of the game. This gaming machine is able to run a bonus game when a bonus trigger is established in the normal game and to trigger a bonus game in the bonus game.

### BRIEF SUMMARY OF THE INVENTION

As described above, it has been important to repeat the bonus game to enhance players' interest in the game and the value of the gaming machine.

An object of the present invention is to provide an information processor, a recording medium, and a game control method, which allow the frequency of repetition of a bonus game to be easily adjusted.

An information processor of the present invention includes: a display configured to display an image; and a controller programmed to execute processes of: starting a base game on the display; determining a bonus trigger at a predetermined probability based on base game probability determination data; in the base game, running, on the display, a bonus game based on bonus game probability determination data with which the game can be more advantageous than the base game, when the bonus trigger is determined; and executing a random determination game including random determination of whether to continue the bonus game based on random determination game probability determination data which is different from the base game probability determination data and the bonus game probability determination data, after the running of the bonus game.

According to the arrangement above, in the random determination game which is run after the end of the bonus game, random determination of whether to continue the bonus game is executed based on the random determination game probability determination data which is different from the base game probability determination data and the bonus game probability determination data. With this, because the design of the probability of whether to continue the bonus game is separated from the design of the probabilities in random determinations including determinations of prizes in the base game and the bonus game, the frequency of repetition of the bonus game is easily adjustable.

The information processor of the present invention may be arranged such that the base game is a game which is run by using plural types of game symbols displayed on the display, a touch panel for receiving a player's input is provided on the front surface side of the display, and the controller is programmed to execute a process of displaying, on the display, a betting area on which betting on the base game is placed, a process of receiving the betting on the betting area based on a player's input to the touch panel, and a process of emphasizing a bet amount corresponding to the player's input in the process of receiving the betting.

According to this arrangement, an erroneous input of a bet amount is restrained as the bet amount is emphasized at the time of input to the touch panel.

An information processor of the present invention includes: a display configured to display an image; and a controller programmed to execute the following processes.

The processes are of displaying, on the display, symbol display areas, on which slot symbols are varied and stopped, to form plural rows and columns; varying and stopping the slot symbols in accordance with a random number obtained by random number determination and awarding a prize based on the arrangement of the stopped slot symbols; when a result of running a base game which is a type of the slot game is a bonus trigger in the process of running the slot game, running a bonus game different from the base game, as a type of the slot game; and running a random determination game which awards a prize including the bonus game based on a random number determined by random number determination after the end of the running of the bonus game.

With this arrangement, in the random determination game which is run after the end of the bonus game, the frequency of repetition of the bonus game in the slot game is easily adjustable by changing the probability of awarding of the bonus game as a prize by adjusting the random number determination.

The information processor of the present invention may be arranged such that the bonus game is plural times of execution of the free game, and the random determination game includes, as the prize, plural bonus games which are different from one another in the number of times of execution of the free game.

According to this arrangement, as the number of times of execution of the free game in the bonus game is changed, it is possible to easily adjust the winning probability of a prize in the entire games including the base game and the bonus game.

The information processor of the present invention may be arranged such that, when the bonus game is not awarded as the prize in the random determination game, a payout is awarded as the prize.

According to this arrangement, devaluation of the random determination game is prevented because a payout is awarded as a prize when the bonus game is not awarded as a prize in the random determination game after the bonus game.

The information processor of the present invention may be arranged such that, in the random determination game, the controller is programmed to vary and stop a random determination symbol in accordance with a random number obtained in the random number determination on win display areas associated with prizes including the bonus game, and to execute a process of awarding a prize corresponding to one of the win display areas, where the random determination symbol stops.

According to this arrangement, in the random determination game after the end of the bonus game, the process of winning the bonus game is visually shown for the player.

The information processor of the present invention may be arranged such that a touch panel for receiving a player's input is provided on the entire surface of the display, and the controller is programmed to execute, when a first condition is established, a process of stopping the slot symbols in the slot game based on the player's input to the touch panel, in addition to a random number obtained by the random number determination, and to execute, when a second condition is established, a process of stopping the random determination symbols in the random determination game based on the player's input to the touch panel, in addition to a random number obtained by the random number determination.

According to this arrangement, the stop of the slot symbols in the slot game is easily done by a player's input to the touch panel when the first condition is established, and the stop of the random determination symbols in the random determination game is easily done by a player's input to the touch panel when the second condition is established.

A recording medium of the present invention stores a game program, the game program causing a computer provided with a display displaying an image to execute: a process of running a base game by using game symbols displayed on the display; a process of varying and stopping the game symbols and determining an execution result of the base game based on the stopped game symbols; a process of running a bonus game by using game symbols displayed on the display when the execution result of the base game is a bonus trigger; and a process of running, by means of random number determination, a random determination game which results in execution results including the bonus game, after the running of the bonus game.

With this arrangement, in the random determination game which is run after the end of the bonus game, the frequency of repetition of the bonus game is easily adjustable by changing the probability of awarding of the bonus game as a prize by adjusting the random number determination.

A game control method of the present invention is executed by a computer provided with a display displaying an image, the method causing the computer to execute: a process of running a base game by using game symbols displayed on the display; a process of varying and stopping the game symbols and determining an execution result of the base game based on the stopped game symbols; a process of running a bonus game by using game symbols displayed on the display when the execution result of the base game is a bonus trigger; and a process of running, by means of random number determination, a random determination game which results in execution results including the bonus game, after the running of the bonus game.

With this arrangement, in the random determination game which is run after the end of the bonus game, the frequency of repetition of the bonus game is easily adjustable by changing the probability of awarding of the bonus game as a prize by adjusting the random number determination.

According to the present invention, the frequency of repetition of a bonus game is easily adjusted.

### BRIEF DESCRIPTION OF THE DRAWINGS

FIG. 1 illustrates the outline of an information processor.

FIG. 2 is an electrical block diagram of the information processor.

FIG. 3 illustrates image display on the information processor.

FIG. 4 is a functional block diagram of the information processor.

FIG. 5 illustrates a game content.

FIG. 6 illustrates a random determination game.

FIG. 7 illustrates the random determination game.

FIG. 8 illustrates the random determination game.

FIG. 9 is a flowchart of a slot game process.

FIG. 10 is a flowchart of a bonus game process.

FIG. 11 is a flowchart of a random determination game process.

### DETAILED DESCRIPTION OF THE PREFERRED EMBODIMENT

(Information Processor: Outline)

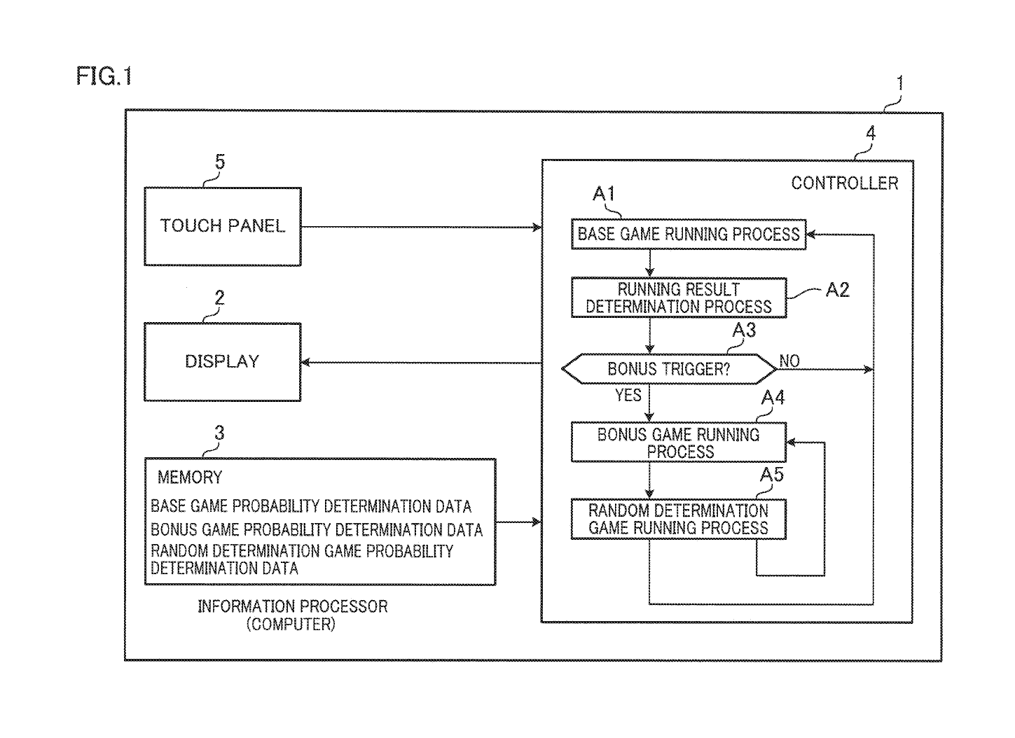

As shown in FIG. 1, an information processor 1 which is a computer is able to easily adjust the frequency of repetition of a bonus game because it has an arrangement that the probability of awarding of the bonus game is changed by adjustment of random number determination in a random determination game which is executed after the end of the bonus game.

To be more specific, the information processor 1 includes a display 2, a memory 3, and a controller 4. The information processor 1 may be a mobile device or a desktop device. Examples of the mobile information processor 1 include mobile information devices such as a portable computer, a laptop computer, a note PC, a tablet PC, a handheld PC, a PDA (Personal Data Assistant), and a smartphone.

The display 2 is configured to be able to display images. The display method of the display 2 is, for example, liquid crystal, organic electroluminescence, CRT (Cathode Ray Tube), and plasma.

The memory 3 stores sets of data such as base game probability determination data used in a base game, bonus game probability determination data used in a bonus game, and random determination game probability determination data used in a random determination game. The memory 3 further stores a program executed by the controller 4. The data and program in the memory 3 may be stored in advance at the stage of factory shipment, or may be downloaded from an unillustrated server or the like via communication means and stored. The communication means may be an interactive communication passage such as the Internet and a cable TV, or may be one-way broadcasting.

Alternatively, the data and program stored in the memory 3 may be stored in a recording medium such as a floppy disk, a CD-ROM, a DVD-ROM, an MO (optical magnetic disc), and a flash memory, and may be read from the recording medium and installed in the memory according to need.

The program stored in the memory 3 causes the information processor 1 (computer) to execute a process of running a base game by using game symbols displayed on the display 2 (A1), a process of varying and stopping the game symbols and determining an execution result of the base game based on the stopped game symbols (A2), a process of running a bonus game by using game symbols displayed on the display 2 (A4) when the execution result of the base game is a bonus trigger (YES in A3), and a process of running, by means of random number determination, a random determination game which results in execution results including the bonus game (A5), after the running of the bonus game.

With this arrangement, in the random determination game which is run after the end of the bonus game, the frequency of repetition of the bonus game is easily adjustable by changing the probability of awarding of the bonus game as a prize by adjusting the random number determination. In addition to the above, as the information processor 1 provided with the program above executes the processes (A1) to (A5), a game control method in which the processes (A1) to (A5) are executed by the information processor 1 (computer) is embodied. While the descriptions below deal with the information processor 1, processes and operations of the information processor 1 can be interpreted as those of a program or a game control method.

The adjustment of the frequency of repetition of the bonus game may be realized by the following arrangement. That is to say, the information processor 1 includes the display 2 configured to display images and the controller 4 programmed to execute processes (A1) to (A5) below. The program includes a process of starting and running a base game on the display (A1), a process of determining a bonus trigger at a predetermined probability based on the base game probability determination data (A2) in the base game, a process of running, on the display 2, a bonus game based on the bonus game probability determination data with which the game can be more advantageous than the base game (A4), when the bonus trigger is determined (YES in A3), and a process of executing a random determination game including random determination of whether to continue the bonus game based on the random determination game probability determination data which is different from the base game probability determination data and the bonus game probability determination data, after the running of the bonus game (A5).

In this way, in the random determination game which is run after the end of the bonus game, random determination of whether to continue the bonus game is executed based on the random determination game probability determination data which is different from the base game probability determination data and the bonus game probability determination data. Because the design of the probability of whether to continue the bonus game is separated from the design of the probabilities in random determinations including determinations of prizes in the base game and the bonus game, the frequency of repetition of the bonus game is easily adjustable.

The phrase “the game can be more advantageous than the base game” indicates, for example, a state in which, as the bonus game probability determination data which is different from the base game probability determination data used in the base game is used, the probability of receiving a prize as a result of random determination based on the bonus game probability determination data is higher than the probability of receiving the same prize as a result of random determination based on the base game probability determination data.

In addition to the above, in the information processor 1 in which the base game in (A1) is a game which is run by using plural types of game symbols displayed on the display 2 and a touch panel 5 for receiving a player's input is provided on the front surface side of the display 2, the controller 4 may be programmed to execute a process of displaying a betting area on which betting on the base game is placed on the display 2, a process of receiving the betting on the betting area based on a player's input to the touch panel 5, and a process of emphasizing a bet amount corresponding to the player's input in the process of receiving the betting. According to this arrangement, an erroneous input of a bet amount is restrained as the bet amount is emphasized at the time of input to the touch panel 5.

### Information Processor 1: Specific Example

An example of the information processor 1 will be specifically described. While the descriptions below deal with a case where a slot game in which a game result is obtained based on symbols of video reels after being varied and stopped is run, the disclosure is not limited to this. In other words, the information processor 1 may be differently structured on condition that the processor is able to run a base game, a bonus game triggered in the base game, and a random determination game which is run after the end of the bonus game.

### Information Processor 1: Specific Example: Electrical Structure

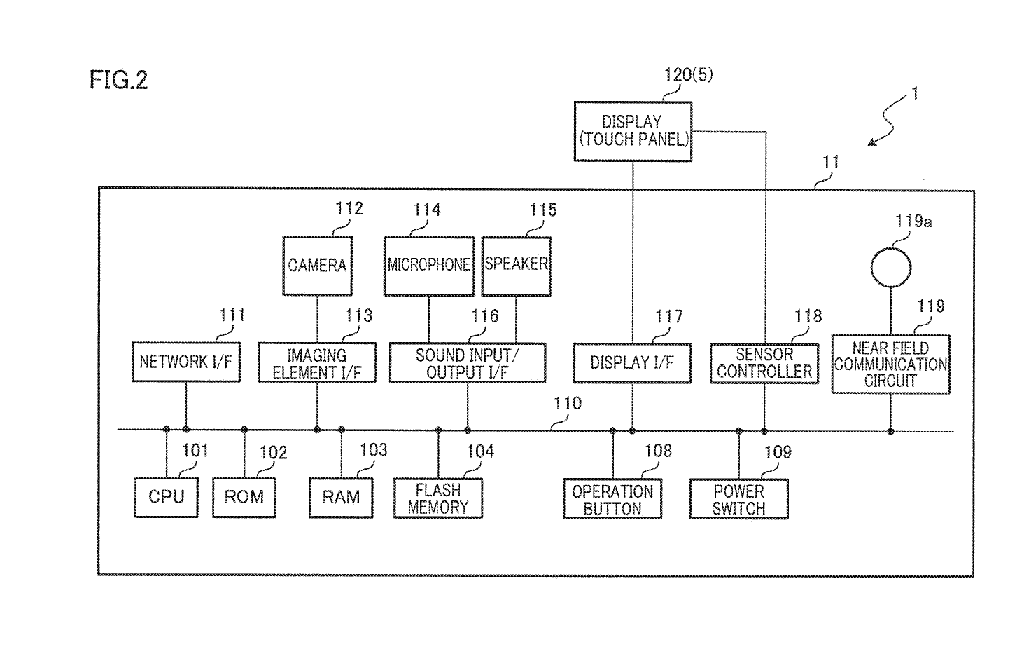

As shown in FIG. 2, the information processor 1 includes, in a housing 11, a CPU 101, a ROM 102, a RAM 103, a flash memory 104, an operation button 108, a power switch 109, a bus line 110, a network I/F 111, a camera 112, an imaging element I/F 113, a microphone 114, a speaker 115, a sound input/output I/F 116, a display I/F 117, a sensor controller 118, a near field communication circuit 119, and an antenna 119a of the near field communication circuit 119.

The CPU (Central Processing Unit) 101 controls the entire information processor 1. The ROM (Read Only Memory) 102 stores programs used for driving the CPU 101, such as an IPL (Initial Program Loader). The ROM 102 may store the program for executing the processes (A1) to (A5).

The RAM (Random Access Memory) 103 is used as a work area of the CPU 101. The flash memory 104 stores the game program for executing the processes (A1) to (A5) shown in FIG. 1, a program for communication, and plural sets of data such as image data and sound data. The operation button 108 is used for, for example, initial setting of the information processor 1. The power switch 109 is used for turning on/off the power source of the information processor 1.

The network I/F (Interface) 111 is an interface for performing data communication by utilizing a communication network such as the Internet. The camera 112 is a built-in camera image capturing means which captures an image of an object to obtain image data under the control of the CPU 101. The imaging element I/F 113 is a circuit for controlling the camera 112. The microphone 114 is a built-in sound collection means to which sound is input. The sound input/output I/F 116 is a circuit for processing input and output of a sound signal between the microphone 114 and the speaker 115 under the control of the CPU 101. The display I/F 117 is a circuit for sending image data to the display 120 under the control of the CPU 101. The display 120 is provided on the front surface of the housing 11. The sensor controller 118 is a circuit for receiving an input from the touch panel 5 of the display 120. The near field communication circuit 119 is a communication circuit based on NFC (Near Field Communication) (Registered Trademark). Bluetooth (Registered Trademark), or the like. The bus line 110 is an address bus, a data bus, or the like for electrically connecting the components such as the CPU 101.

### Information Processor 1: Specific Example: Slot Game

In the information processor 1 having the electrical structure described above, the CPU 101 is programmed to execute the processes (A1) to (A5) shown in FIG. 1. The program includes processes of displaying, on the display 2, symbol display areas, on which slot symbols are varied and stopped, to form plural rows and columns (A1), varying and stopping the slot symbols in accordance with a random number obtained by random number determination and awarding a prize based on the arrangement of the stopped slot symbols (A2), when a result of running a base game which is a type of the slot game is a bonus trigger in a process of running the slot game (YES in A3), running a bonus game different from the base game, as a type of the slot game (A4), and running a random determination game which awards a prize including the bonus game based on a random number determined by random number determination (A5) after the end of the running of the bonus game.

In this way, the information processor 1 is a gaming machine configured to run the slot game. In other words, the information processor 1 is a gaming machine in which, in the random determination game which is run after the end of the bonus game, the frequency of repetition of the bonus game in the slot game is easily adjustable by changing the probability of awarding the bonus game as a prize by adjusting the random number determination.

The bonus game in the process (A4) shown in FIG. 1 may be plural times of execution of the free game, and the random determination game in the process (A5) may include, as a prize, plural bonus games which are different from one another in the number of times of execution of the free game. According to this arrangement, as the number of times of execution of the free game in the bonus game is changed, it is possible to easily adjust the winning probability of a prize in the entire games including the base game and the bonus game.

In addition to the above, for example, when a first condition is satisfied as in a case where the bonus game is won in the random determination game, the stop of the slot symbols in the slot game may be based on a player's input to the touch panel 5, in addition to a random number obtained by random number determination.

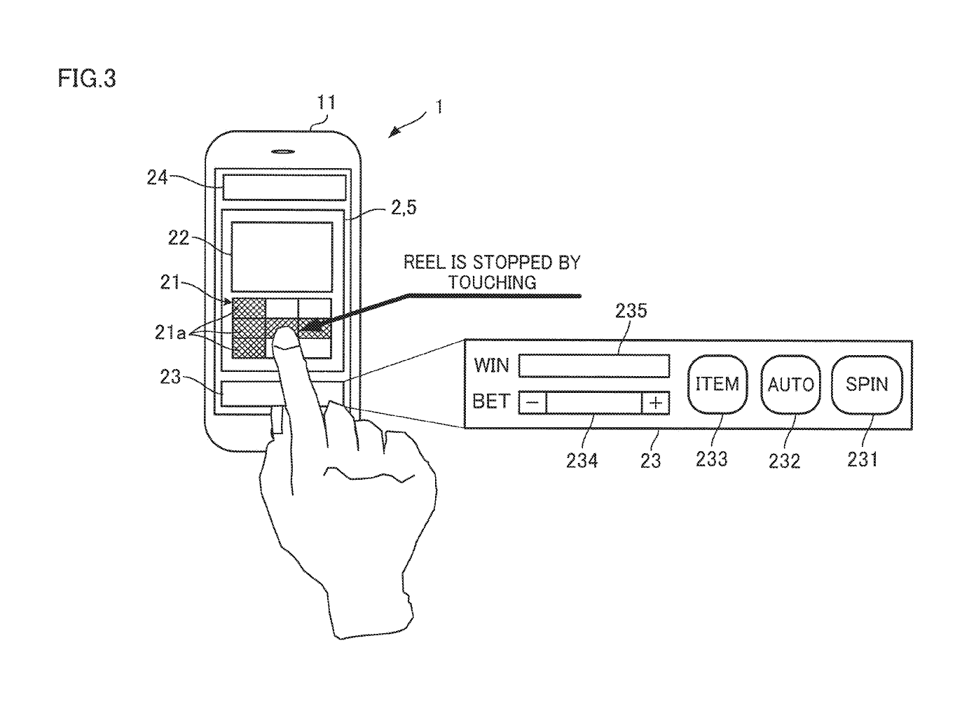

As shown in FIG. 3, the information processor 1 which is a gaming machine running the slot game displays a slot game screen on the display 2. The slot game screen includes a game area 21 where symbol display areas 21a are displayed to form plural rows and columns, an effect area 22 where moving images and still images such as game characters are displayed in accordance with the slot game, an operation area 23 which is operated by the player to progress the game, and a game information display area 24 which displays game contents and game information. The operation area 23 includes a spin button 231, an AUTO button 232, an ITEM button 233, a bet button 234, and a WIN display portion 235, which are images.

On the entire surface of the display 2, a touch panel 5 which allows the game screen to be viewable from the outside is provided. The touch panel 5 makes it possible to detect the coordinates of a part touched by a player's finger or the like. With this arrangement, for example, the slot game (unit game) is executed once, as the image of the spin button 231 is pressed. Furthermore, the slot game is serially executed plural times as the image of the AUTO button 232 is pressed.

### Information Processor 1: Specific Example: Slot Game: Definitions

The base game in the slot game of the present embodiment is a game in which plural symbols are displayed (arranged) by being varied and then stopped in the game area 21, and includes a normal game. A state in which a symbol is displayed after being varied and stopped in the game area 21 is termed “rearrangement”. As a bonus game, the free game is executed at least once in the slot game. The slot game may include a process of executing a free game where symbols are rearranged on condition that the payout rate is higher than the payout rate in the normal game and a bonus payout is awarded in accordance with the rearranged symbols.

A gaming value which is awarded when a prize is established as a result of a game result is a coin, paper money, or electrically valuable information corresponding to these. Note that the gaming value in the present invention is not particularly limited. Examples of the gaming value include game media such as medals, tokens, electronic money, tickets, and the like. A ticket is not particularly limited, and a barcoded ticket may be adopted for example. Alternatively, the gaming value may be a game point not including valuable information.

The free game is a game which is executable with a smaller amount of gaming values bet than in the normal game. Note that “bet of smaller amounts of gaming values” encompasses a bet of zero gaming value. The “free game” therefore may be a game runnable without a bet of a gaming value, which free game awards an amount of gaming values based on symbols rearranged. In other words, the “free game” may be a game which starts without consumption of a gaming value. To the contrary, the “normal game” is a game runnable on condition that a gaming value is bet, which normal game awards an amount of gaming value based on the symbols rearranged. In other words, the “normal game” is a game which starts with consumption of a gaming value.

The “unit game” is a series of operations from the start of the receiving of a bet to a state in which an award can be established. To put it differently, the unit game includes a single bet time for receiving a bet, a single game time of rearranging stopped symbols, and a single payout time of a payout process of awarding a payout.

A state in which a symbol is displayed after being varied and stopped in the game area 21 is termed “rearrangement”. To put it differently, the term “rearrangement” indicates that the symbols are rearranged after the arrangement of the symbols is dismissed. The term “arrangement” indicates a state in which the symbols are visually recognizable by an external player.

### Information Processor 1: Specific Examples: Functional Blocks

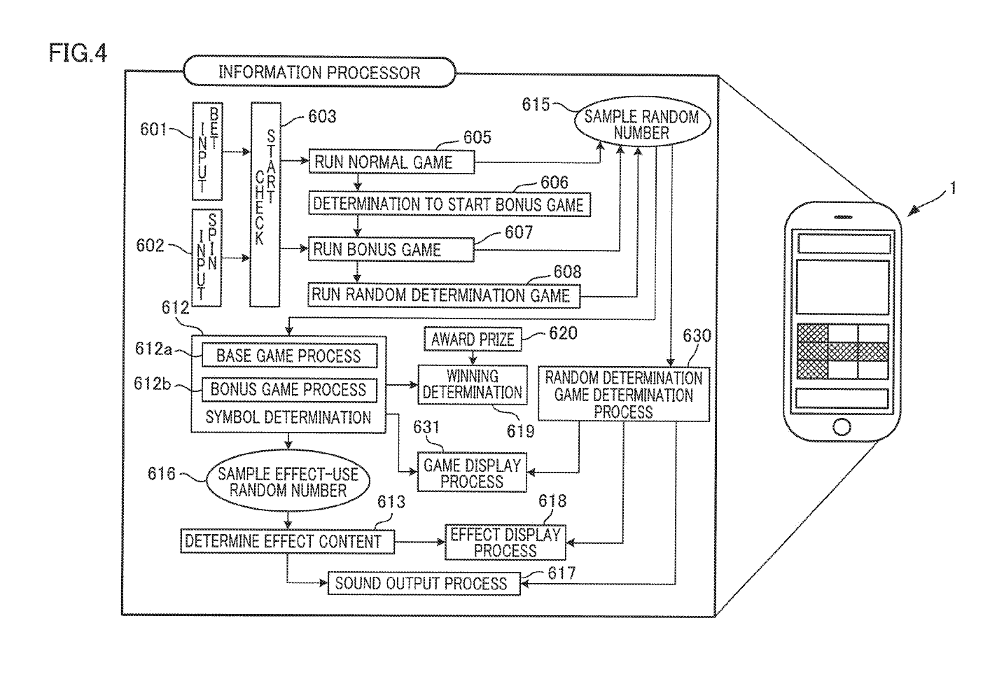

As shown in FIG. 4, the information processor 1 which is the gaming machine running the slot game has the following functions. To be more specific, the information processor 1 includes a BET input unit 601 and a spin input unit 602. The BET input unit 601 and the spin input unit 602 are input devices. The BET input unit 601 has a function of receiving a bet in response to a player's operation. The spin input unit 602 has a function of receiving a player's operation, i.e., a start instruction to start a game.

The information processor 1 includes a start check unit 603, a normal game running unit 605, a bonus game start determining unit 606, a bonus game running unit 607, a random determination game running unit 608, a random number sampling unit 615, a symbol determining unit 612, an effect-use random number sampling unit 616, an effect content determining unit 613, a sound output unit 617, an effect display processing unit 618, a winning determining unit 619, a prize awarding unit 620, a random determination game determination processing unit 630, and a game display processing unit 631.

The normal game running unit 605 has a function of running a normal game which is a base game, on condition that the BET input unit 601 is operated. The bonus game start determining unit 606 determines whether to run a bonus game, based on a combination of the symbols rearranged in the normal game. In other words, the bonus game start determining unit 606 has functions of: determining that the player is entitled to a bonus game when a bonus symbol is rearranged; and activating the bonus game running unit 607 so as to run a bonus game from the subsequent unit game. The random determination game running unit 608 has a function of randomly determining prizes including the bonus game. As this function is executed after the execution by the bonus game running unit 607, the bonus game can be repeatedly run.

The symbol determining unit 612 includes a base game processing unit 612a and a bonus game processing unit 612b. The symbol determining unit 612 including these processing units 612a and 612b has functions of: determining symbols to be rearranged based on a random number given from the random number sampling unit 615; rearranging the determined symbols in the display 11; outputting rearrangement information of the symbols to the winning determining unit 619; and outputting an effect instruction signal to the effect-use random number sampling unit 616, based on the combination of the rearranged symbols.

The effect-use random number sampling unit 616 has a function of sampling an effect random number when receiving an effect instruction signal from the symbol determining unit 612 and a function of outputting the effect random number to the effect content determining unit 613. The effect content determining unit 613 has functions of: determining an effect content by using the effect-use random number; outputting image information on the determined effect content to the effect display processing unit 618; and outputting audio and illumination information of the determined effect content to the sound output unit 617.

The winning determining unit 619 has functions of: determining whether a winning is achieved based on a combination of symbols when information rearrangement information of the symbols is given; calculating an amount of payout based on a winning combination formed when it is determined that a winning has been achieved; and outputting, to the prize awarding unit 620, a payout signal which is based on the payout amount. The prize awarding unit 620 has a function of payout out a gaming value to the player.

The random determination game determination processing unit 630 has a function of running a random determination game of awarding prizes including the bonus game based on a random number obtained by random number determination after the end of the bonus game, and outputs effect data of the random determination game to the game display processing unit 631, the effect display processing unit 618, and the sound output unit 617. The details of the random determination game in the random determination game determination processing unit 630 will be given later.

### Information Processor 1: Specific Example: Game Content

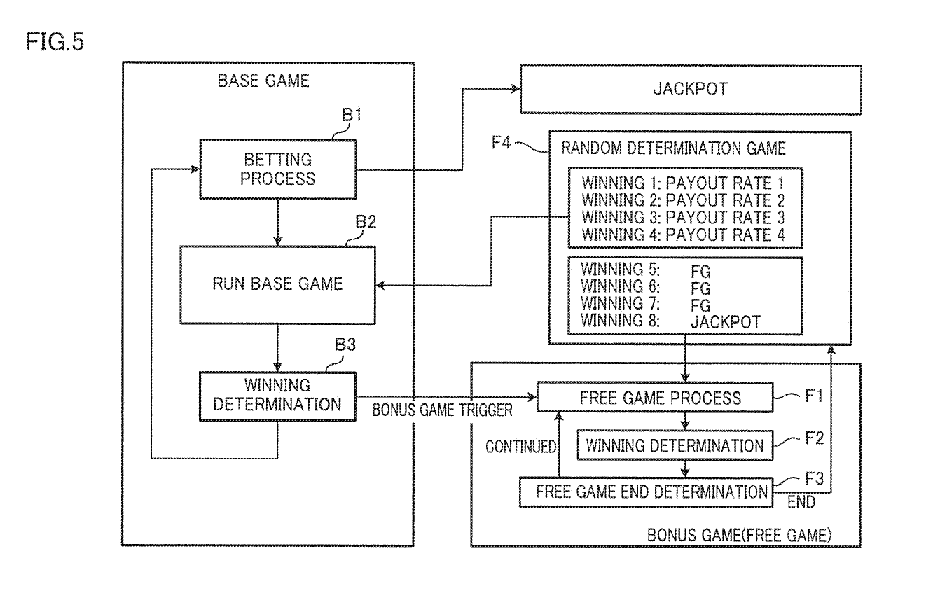

FIG. 5 shows the shift of the state in the information processor 1 which is a gaming machine. To be more specific, the figure shows the shift between a base game mode, a bonus game mode (free game), and a random determination game mode. The base game mode is a game state during the normal game, whereas the bonus game mode is equivalent to a game state in the free game.

The information processor 1 has three game modes, namely the base game mode, the bonus game mode, and the random determination game mode. The information processor 1 shifts to the bonus game mode when the unit game is run in the base game mode and a bonus trigger condition is satisfied in the base game mode. The trigger of the bonus game is, for example, a condition in which three or more bonus symbols consecutively appear (are rearranged) from the first reel. The trigger of the bonus game may be another condition.

### Information Processor 1: Specific Example: Game Content: Base Game Mode

The base game mode is specifically described. In the game area 21 displayed on the display 11 shown in FIG. 3, symbols for the slot game are rearrangeable on the video reels with three rows and three columns. In a betting process (B1), a bet amount is selected by the player. The bet amount is, for example, selected from numbers such as 1, 2, 3, 5, and 10 by operating the bet button 234. The resource generated by accumulating parts of bet amounts is termed jackpot.

Thereafter, as the symbols are rearranged by varying (scroll-moving) and stopping (scroll-stop) the video reels, whether winning is achieved is determined and win determination is performed based on the state of the rearranged symbols (B3). For example, the bonus game trigger is established when the bonus symbols are consecutively rearranged from the first column area (first reel) to the third column area (third reel). The bonus game trigger is also established when the bonus symbols and a wild symbol which is able to substitute for the bonus symbol are consecutively rearranged.

### Information Processor 1: Specific Example: Game Content: Bonus Game Mode

The base game mode shifts to the bonus game mode when the trigger condition of the bonus game is established, and a free game process is executed, to begin with (F1).

In the free game process, free game reel strips used in the free game are determined, and a predetermined number of times of execution of the free game is set. The reel strips for the free game and the number of times of execution of the free game may be randomly chosen from plural selected options.

As the free game is run, win determination is executed (F2). This win determination may be identical with the win determination in the base game (B3). For example, when three or more bonus symbols consecutively appear from the first reel, the retrigger condition of the bonus game (free game) is established.

Thereafter, whether the free game ends is determined (F3). If the free game has not ended (i.e., continued), the free game is run for the remaining number of times in F1. When the free game has ended, the mode shifts to the random determination game (F4).

### Information Processor 1: Specific Example: Game Content: Random Determination Game Mode

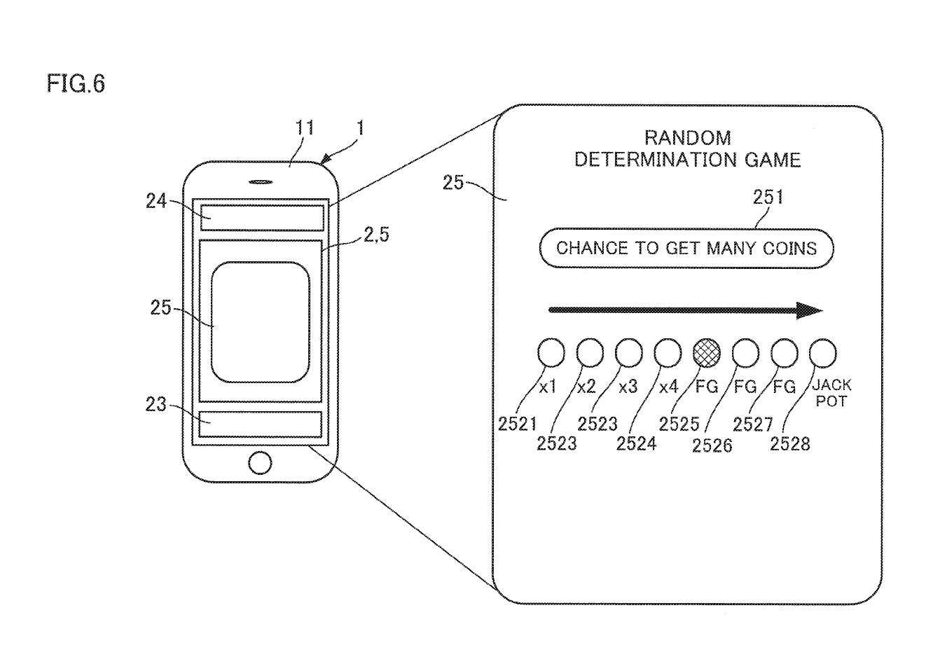

As shown in FIG. 6, the random determination game is run such that a random determination game screen 25 is displayed on the display 2. The random determination game screen 25 includes an effect comment screen 251 showing comments such as “Chance to Get Many Coins” and a first winning portion 2521 to an eighth winning portion 2528 which are eight win display areas.

The winning portions 2521 to 2528 are associated with prizes including the bonus game. To be more specific, the first winning portion 2521 is associated with a prize awarding a payout calculated by multiplying the total payout of the bonus game (in which the free game is executed more than once) executed before the random determination game by one. The second winning portion 2522 is associated with a prize awarding a payout calculated by multiplying the above-described total payout by two. The third winning portion 2523 is associated with a prize awarding a payout calculated by multiplying the above-described total payout by three. The fourth winning portion 2524 is associated with a prize awarding a payout calculated by multiplying the above-described total payout by four. The fifth winning portion 2525 is associated with a prize of running a bonus game in which the free game is run five times. The sixth winning portion 2526 is associated with a prize of running a bonus game in which the free game is run 10 times. The seventh winning portion 2527 is associated with a prize of running a bonus game in which the free game is run 15 times. The eighth winning portion 2528 is associated with a prize of jackpot. This jackpot is a payout typically larger than payouts obtained based on combinations of stopped symbols in the base game, and includes a type (progressive jackpot) in which a payout results from accumulation of a part of each bet.

When one of the first winning portion 2521 to the fourth winning portion 2524 is selected, shift to the base game occurs. In this connection, when the bonus game is not awarded as a prize in the random determination game, a payout may be awarded as a prize. For example, in the first execution of the base game after the shift from the random determination game, a payout may be awarded with the payout rate of the one of the first winning portion 2521 to the fourth winning portion 2524, as a symbol stop table with which a prize is always awarded is used. Alternatively, a payout calculated by multiplying a predetermined payout amount by a payout rate may be awarded before the shift from the random determination game to the base game. In this case, devaluation of the random determination game is prevented because a payout is awarded as a prize when the bonus game is not awarded as a prize in the random determination game after the bonus game.

One of the first winning portion 2521 to the eighth winning portion 2528 is selected by random number determination. The random determination is performed in such a way that continuous numbers are divided into predetermined numerical ranges, these numerical ranges are associated with the respective winning portions 2521 to 2528, and one of the winning portions 2521 to 2528, which is associated with the numerical range including the selected random number, is selected. For example, continuous numbers from 0 to 255 are divided into eight ranges each including 32 numbers, the eight ranges are associated with the respective winning portions 2521 to 2528, and one of the winning portions 2521 to 2528, which is associated with the range including a random number selected from a random number range of 0 to 255, is selected. With this arrangement, when, for example, the first winning portion 2521 is associated with the first range of 0 to 31, the second winning portion 2522 is associated with the second range of 32 to 63, and the randomly determined number is 40, the second winning portion 2522 associated with the second range including 40 is selected.

In regard to the ranges associated with the winning portions 2521 to 2528, each of the winning portions 2521 to 2528 is selected at the same probability when each of the ranges is formed of the same numbers, e.g., 32. The disclosure, however, is not limited to this arrangement. The winning probabilities of the ranges associated with the winning portions 2521 to 2528 may be different from one another in accordance with the prizes associated with the respective winning portions 2521 to 2528. For example, the range associated with the winning portion 2528 corresponding to the jackpot may have the lowest winning probability.

In addition to the above, at the start of the random determination game, ranges associated with the winning portions 2521 to 2528 may be randomly determined. Player's interest in the random determination game is enhanced in this case, because the probabilities of winning prizes are changed in each execution of the random determination game. Alternatively, the ranges may be determined in accordance with the total payout amount as compared to the total bet amount within a predetermined time, or the ranges may be determined in accordance with the number of repetition of the bonus game.

A random number effect is performed in such a way that, when a random number is determined, one of the winning portions 2521 to 2528 associated with that random number is highlighted. In this regard, the random determination process is preferably viewable for the player. For example, in the random determination game, a random determination symbol is varied and stopped on the winning portions 2521 to 2528 (win display areas), and a prize corresponding to one of the winning portions 2521 to 2528 where the random determination symbol stops is awarded. In this case, in the random determination game after the end of the bonus game, the process of winning the bonus game is visually shown for the player by the varying display of the random determination symbol.

To be more specific, for example, the winning portions 2521 to 2528 are provided to form a single line in the left-right direction, an operation such as serially changing the color or light intensity from the left end to the right end as indicated by the arrow in the figure or moving a symbol such as an icon is repeated, and the symbol stops at one of the winning portions 2521 to 2528, which is randomly selected after a predetermined time elapses. The random determination symbol includes a change in color, a change in light intensity, and a symbol such as an icon.

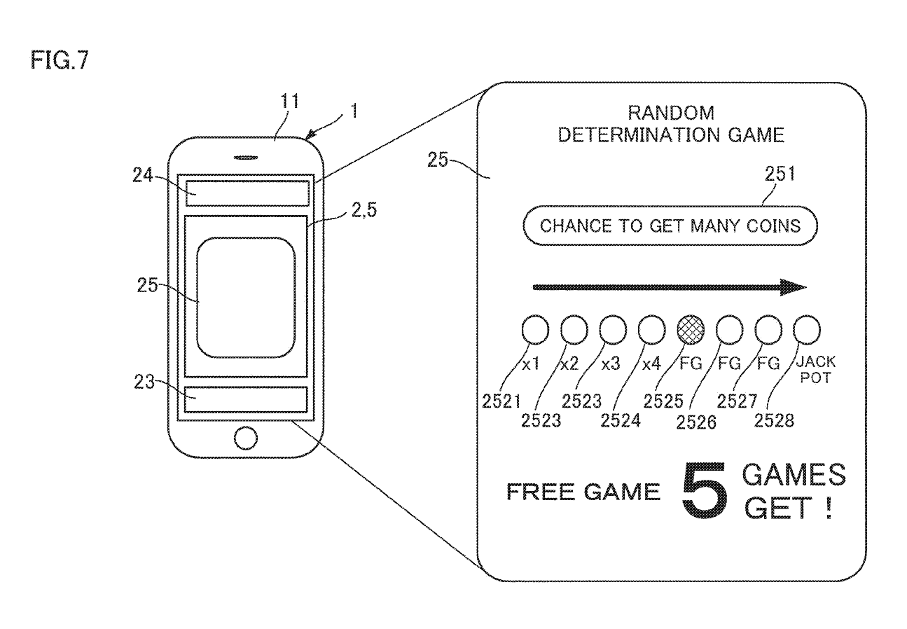

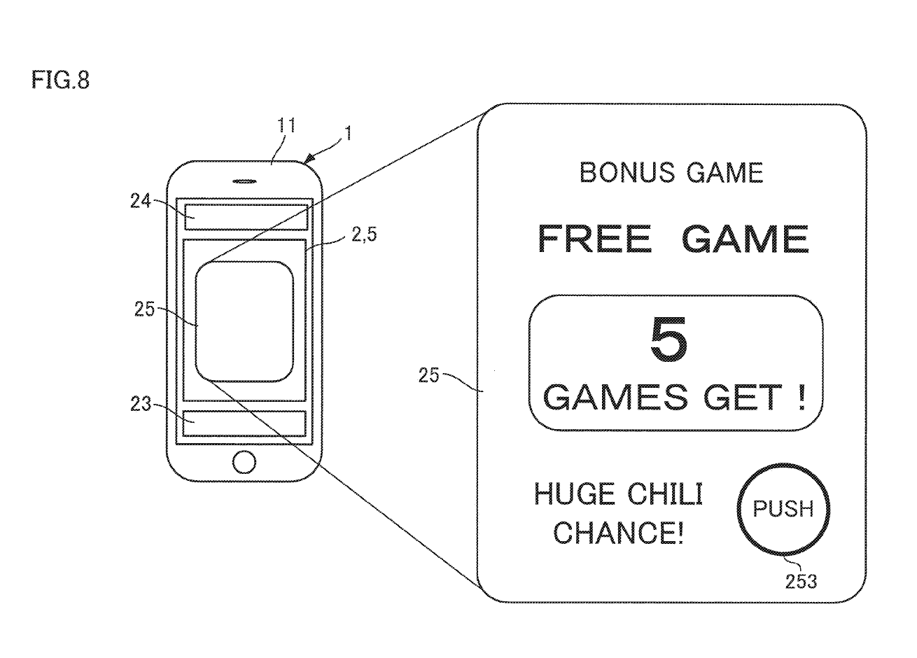

As shown in FIG. 7, when one of the fifth winning portion 2525 to the seventh winning portion 2527 is selected, the number of times of execution of the free game is displayed. Thereafter, as shown in FIG. 8, the screen is switched to a bonus winning effect screen after a predetermined time elapses, and whether to switch to a symbol array of slot symbols including “Huge Chili” symbol is randomly determined based on pressing of the push button 253. The “Huge Chili” symbol is a meaningful symbol formed by two large symbols which are side by side in the moving direction.

When the free game is played with a symbol array of slot symbols including the “Huge Chili” symbol, preferably, it is determined that the first condition in the slot game has been established and the slot symbols are stopped based on a player's input to the touch panel 5. In this case, varying symbols are easily stoppable by using the large “Huge Chili” symbol as a visual mark.

In the random determination game, when a predetermined condition (second condition) is satisfied, the random determination symbols may be stopped based on not only a random number obtained by random number determination but also a player's input to the touch panel 5. In this case, the stop of the random determination symbols in the random determination game is easily done by a player's input to the touch panel 5.

The stop of the random determination symbols based on a player's input is preferably possible only in selected one or more of the winning portions 2521 to 2528. The winning portions can be selected in various ways. For example, the stop of the symbols based on a player's input is prohibited in the eighth winning portion 2528 corresponding to the jackpot, the stop of the symbols based on a player's input is allowed only in the winning portions 2521 to 2524 corresponding to the payout rates, or the stop of the symbols based on a player's input is allowed only in the winning portion 2525 corresponding to the free game. Furthermore, the selection state of the winning portions 2521 to 2528 may be randomly changed in each execution of the unit game which is executed for a predetermined number of times which is one or more, or the selection state may be switched in a predetermined pattern in each execution of the unit game which is executed for the predetermined number of times.

### Information Processor 1: Specific Example: Game Content: Slot Game Process

Now, a program of the slot game executed by the CPU 101 of the information processor 1 will be described.

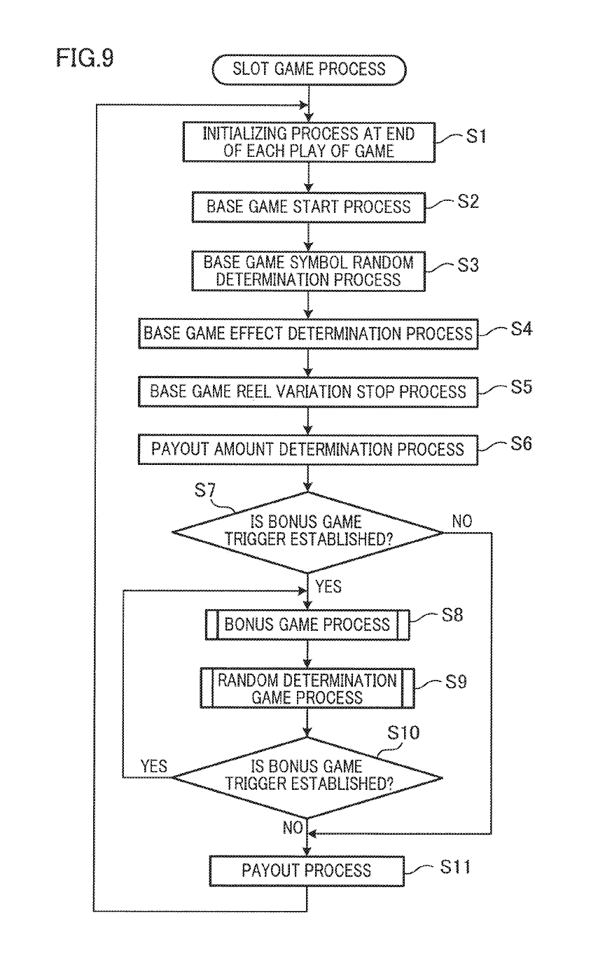

As shown in FIG. 9, an initializing process at the end of each play of the game is executed (S1). For example, this process clears data in a working area of the RAM 103, which becomes unnecessary at the end of each play of game, e.g., the bet amount and symbols selected by random determination. After a base game start process (S2), a base game symbol random determination process is executed (S3). In this process, to-be-stopped symbols are randomly selected and determined based on a random number by using a symbol random determination table.

Then a base game effect determination process is executed (S4). The CPU 101 samples an effect-use random number and randomly determines any of a plurality of predetermined effect contents, and executes the determined effect content at the determined timing. For example, an effect image is displayed in an effect area 22 of the display 120, and sound is output by the speaker 115.

Then a base game reel variation stop process is executed (S5). In this process, the scroll of the symbol columns in the symbol display area 21a starts, and the to-be-stopped symbols determined in the base game symbol random determination process are stopped at predetermined positions.

Then a payout amount determination process is executed (S6). In the base game, a payout amount is determined in accordance with a combination of symbols and based on a payout table, and the determined payout amount is stored in a payout amount storage area of the RAM 103. When the bonus game trigger is established, a payout amount is determined in accordance with a combination of bonus symbols, based on a rule different from the rule in the base game.

Then whether the bonus game trigger has been established is determined (S7). When the bonus game trigger has been established (YES in S7), a bonus game process is executed (S8). Then a later-described random determination game process is executed (S9) and whether the bonus game trigger has been established is determined in the random determination game process (S10). When the bonus game trigger has been established (YES in S10), the bonus game process in S8 is executed again.

In the meanwhile, if the bonus game trigger has not been established in S7 or S10 (NO in S7 or S10), a payout process is executed (S11). The CPU 101 adds a value stored in the payout amount storage area to a value stored in a credit amount storage area (credit counter) provided in the RAM 103. Then the steps are executed again from S1.

### Information Processor 1: Specific Example: Game Content: Bonus Game Process

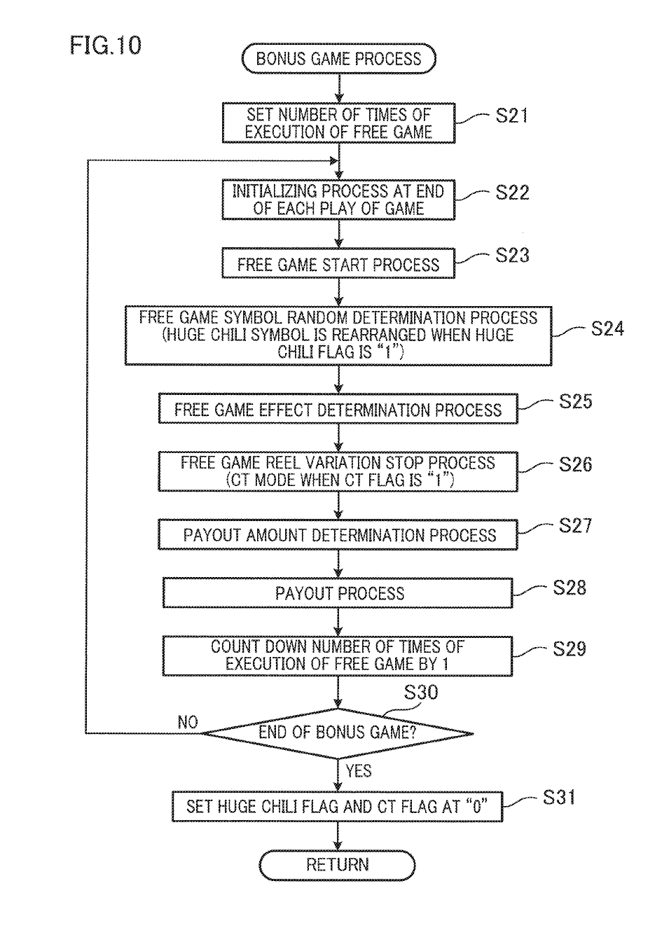

The following describes a bonus game process with reference to FIG. 10. The bonus game process is a process executed when the bonus game trigger is established.

To begin with, the number of times of execution of the free game is set (S21). For example, the number of times of execution of the free game is set at 5. Then an initializing process at the end of each play of the game is executed (S22). For example, this process clears data in a working area of the RAM 103, which becomes unnecessary at the end of each play of game, e.g., the symbols selected by random determination. It is noted that the bet amount in the bonus game is identical with the bet amount in the base game immediately before the shift to the bonus game.

Thereafter, in the same manner as in the base game, a free game start process (S23), a free symbol random determination process (S24), and a free game effect determination process (S25) are executed. In the free game, a free game symbol random determination table different from the symbol random determination table in the base game is used. In the free game symbol random determination process, when a Huge Chili flag is set at 1, random determination is executed such that a Huge Chili symbol is to be rearranged.

Thereafter, a free game reel variation stop process (S26) is executed to vary and stop the reels. In this process, the free game is shifted to a CT mode when a CT flag is set at 1. In this mode, the player is allowed to forcibly stop the reels by an operation. Thereafter, a payout amount determination process (S27) and a payout process (S28) are serially executed, and then the number of times of execution of the free game is counted down by 1 (S29). Then whether the bonus game has ended is determined (S30). When the number of times of execution of the free game is not 0 (NO in S30), the steps are executed again from S22 as it is determined that the bonus game has not ended. In the meanwhile, when the number of times of execution of the free game is 0 (YES in S30), it is determined that the bonus game has ended. Then the Huge Chili flag and the CT flag are set at 0 (S31). As such, the flags are maintained at 0 in the bonus game after the base game, and the flags are changed from 1 to 0 in the bonus game after the random determination game. The process is then terminated and the processing routine shown in FIG. 9 is resumed.

### Information Processor 1: Specific Example: Game Content: Random Determination Game Process

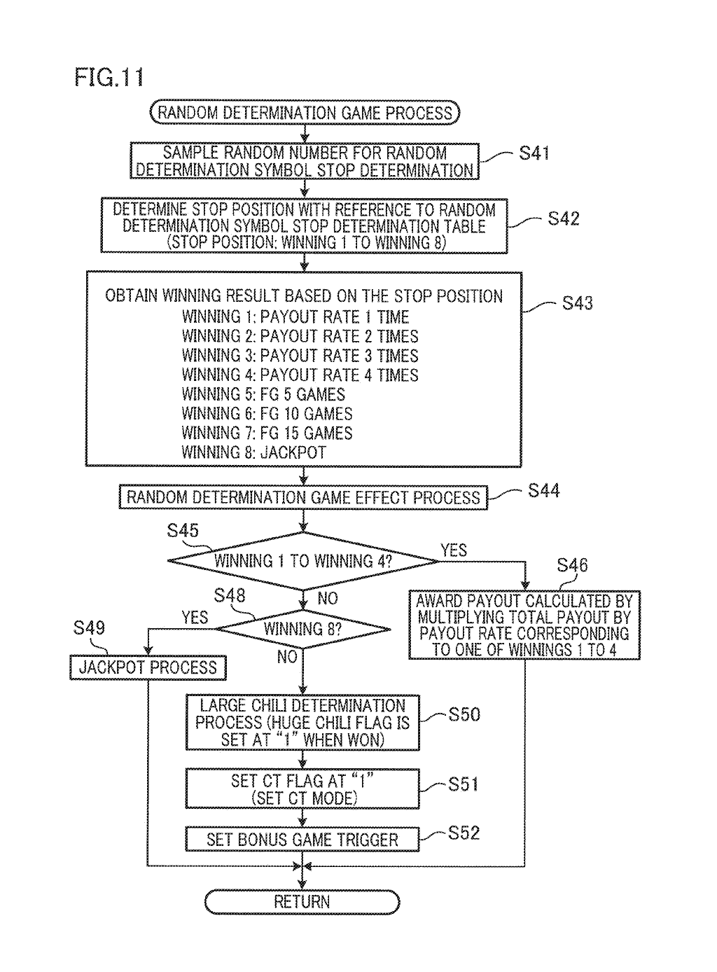

The following describes a random determination game process with reference to FIG. 11. The random determination game process is a process executed when the bonus game ends.

To begin with, a random number for random determination symbol stop determination is sampled (S41). Thereafter, the stop position of the random determination symbol is determined with reference to a random number and the random determination symbol stop determination table (S42). In the present embodiment, the symbol stops at one of the eight winning portions 2521 to 2528. Thereafter, a winning result based on the stop position is obtained (S43). To put it differently, a prize corresponding to one of the winning portions 2521 to 2528 (i.e., one of win 1 to win 8) is obtained. Then an effect corresponding to the winning result is performed (S44).

Subsequently, whether the winning result is one of prizes (win 1 to win 4) is determined (S45). When the result is one of the prizes (win 1 to win 4) (YES in S45), a payout rate corresponding to the one of the prizes (win 1 to win 4) is set and a payout calculated by multiplying the total payout of the bonus game (execution of the free game plural times) run before the random determination game by the payout rate is awarded (S46), and then the routine ends.

In the meanwhile, when the winning result is not one of the prizes (win 1 to win 4) (NO in S45), whether the winning result is a prize (win 8) is determined (S48). When the winning result is the prize (win 8) (YES in S48), the jackpot process is executed, so that the jackpot is paid out and an effect for the jackpot is executed (S49). Then, this routine ends. When the winning result is not the prize (win 8) (NO in S48), a Large Chili determination process is executed (S50). In this process, when the Huge Chili is achieved as a result of random number determination or a player's input to the push button 253 shown in FIG. 8, the Huge Chili flag is set at 1. Then the CT flag is set at 1 (S51), and hence the free game after the shift from the random determination game to the bonus game can be played in the CT mode. After the bonus game trigger is set so that the bonus game is repeated (S52), the routine ends.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

What is claimed is:

1. An information processor comprising:
a display configured to display an image; and
a controller programmed to execute processes of:
starting a base game on the display;
in the base game, determining a bonus trigger at a predetermined probability based on base game probability determination data;
running, on the display, a bonus game based on bonus game probability determination data with which the game can be more advantageous than the base game, when the bonus trigger is determined; and
executing a random determination game including random determination of whether to continue the bonus game based on random determination game probability determination data which is different from the base game probability determination data and the bonus game probability determination data, after the running of the bonus game.

2. The information processor according to claim 1, wherein,
the base game is a game which is run by using plural types of game symbols displayed on the display,
a touch panel for receiving a player's input is provided on the front surface side of the display, and
the controller is programmed to execute
a process of displaying, on the display, a betting area on which betting on the base game is placed,
a process of receiving the betting on the betting area based on a player's input to the touch panel, and
a process of emphasizing a bet amount corresponding to the player's input in the process of receiving the betting.

3. An information processor comprising:
a display configured to display an image; and
a controller programmed to execute processes of:
displaying, on the display, symbol display areas, on which slot symbols are varied and stopped, to form plural rows and columns;
varying and stopping the slot symbols in accordance with a random number obtained by random number determination and awarding a prize based on the arrangement of the stopped slot symbols;
when a result of running a base game which is a type of the slot game is a bonus trigger in the process of running the slot game, running a bonus game different from the base game, as a type of the slot game; and
running a random determination game which awards a prize including the bonus game based on a random number determined by random number determination after the end of the running of the bonus game.

4. The information processor according to claim 3, wherein,
the bonus game is plural times of execution of the free game, and
the random determination game includes, as the prize, plural bonus games which are different from one another in the number of times of execution of the free game.

5. The information processor according to claim 3, wherein, when the bonus game is not awarded as the prize in the random determination game, a payout is awarded as the prize.

6. The information processor according to claim 3, wherein, in the random determination game, the controller is programmed to vary and stop a random determination symbol in accordance with a random number obtained in the random number determination on win display areas associated with prizes including the bonus game, and to execute a process of awarding a prize corresponding to one of the win display areas, where the random determination symbol stops.

7. The information processor according to claim 6, wherein,
a touch panel for receiving a player's input is provided on the entire surface of the display, and
the controller is programmed
to execute, when a first condition is established, a process of stopping the slot symbols in the slot game based on the player's input to the touch panel, in addition to a random number obtained by the random number determination, and
to execute, when a second condition is established, a process of stopping the random determination symbols in the random determination game based on the player's input to the touch panel, in addition to a random number obtained by the random number determination.

8. A recording medium storing a game program, the game program causing a computer provided with a display displaying an image to execute:
a process of running a base game by using game symbols displayed on the display;
a process of varying and stopping the game symbols and determining an execution result of the base game based on the stopped game symbols;
a process of running a bonus game by using game symbols displayed on the display when the execution result of the base game is a bonus trigger; and
a process of running, by means of random number determination, a random determination game which results in execution results including the bonus game, after the running of the bonus game.

9. A game control method executed by a computer provided with a display displaying an image, the method causing the computer to execute:
a process of running a base game by using game symbols displayed on the display;
a process of varying and stopping the game symbols and determining an execution result of the base game based on the stopped game symbols;
a process of running a bonus game by using game symbols displayed on the display when the execution result of the base game is a bonus trigger; and
a process of running, by means of random number determination, a random determination game which results in execution results including the bonus game, after the running of the bonus game.
